(19) United States
(12) Patent Application Publication
(10) Pub. No.: US 2010/0083043 A1
(43) Pub. Date: Apr. 1, 2010

(54) INFORMATION PROCESSING DEVICE, RECORDING MEDIUM THAT RECORDS AN OPERATION STATE MONITORING PROGRAM, AND OPERATION STATE MONITORING METHOD

(75) Inventor: Fumiki NIIOKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/563,451

(22) Filed: Sep. 21, 2009

(30) Foreign Application Priority Data
Oct. 1, 2008 (JP) 2008-255918

(51) Int. Cl. G06F 11/07

(52) U.S. Cl. 714/23; 714/E11.023

(57) ABSTRACT

The device and method includes outputting a subsistence signal repeatedly that indicates that an information processing device is normally operating when the information processing unit is normally operating, executing a memory dump processing, if necessary, when a fault occurs in the information processing unit, monitoring whether another subsistence signal is output within a first time period after the subsistence signal is output, and determining whether or not the memory dump processing is being executed, requesting a restart or a shutdown of the information processing device if the memory dump processing is not being executed, and requesting the restart or the shut down of the information processing device after a second time period passes if the memory dump processing is being executed.

### CROSS-REFERENCE TO RELATED APPLICATIONS

This application is based upon and claims the benefit of priority of the prior Japanese Patent Application No. 2008-255918, filed on Oct. 1, 2008, the entire contents of which are incorporated herein by reference.

### BACKGROUND

1. Field

The present invention is related to an information processing device, operation state monitoring device and method thereof, and more particularly, to a memory dump processing of a memory content.

2. Description of the Related Art

Memory dumping is generally a processing that is executed when a fault occurs in a computer system. Memory dump processing is executed to store (dump) a memory content of a memory at a time in a specified nonvolatile area, for example, when a program is improperly finished. The dumped content is used to analyze a problem of the program later on. Such a memory dump function is often mounted on an Operating System (OS).

Meanwhile, as another function for responding to occurrence of a fault, a monitoring function of a system using a so-called Watchdog Timer has been known. The watchdog timer monitors a subsistence signal, which is output by a function of the OS or the like, indicating that the system is being normally operating, at specified intervals. If the subsistence signal is not received, the watchdog timer determines that a fault occurs in the system. In this case, the system is automatically restarted or shut down.

As a technique related to the above-described function, there is a known calculator that executes memory dump processing. The calculator has a configuration in which a monitor OS monitors a control OS that executes applications. The control OS transmits a subsistence signal to the monitor OS at specified intervals. The monitor OS detects an abnormality of the control OS by detecting disruption of the subsistence signal. Furthermore, there is a known calculator system in which a dump calculator reads out fault information from a specified area of a memory area in a target calculator and the target calculator is rebooted in response to an instruction from the dump calculator.

Furthermore, in the calculator system, when occurrence of a fault is detected, the state monitoring unit requests execution of a memory dump collection program by interruption, and starts own count processing. Counting is stopped if the memory dump collection program is started normally. If the counting is not stopped, that is, if the memory dump collection is not performed, the system is reset.

### SUMMARY

According to an aspect of the invention, an information processing device that has a memory dump processing function for collecting a memory content of a memory and recording the memory content in a nonvolatile storage area is provided. The information processing device includes a subsistence signal output unit that repeatedly outputs a subsistence signal indicating that the information processing device is normally operating when the information processing unit is normally operating, a memory dump processing unit that executes a memory dump processing when necessary, in reference to processing of the subsistence signal output unit when a fault occurs in the information processing unit, a subsistence signal monitoring unit that monitors whether another subsistence signal is output again within a first time period after the subsistence signal is output, and a system state determination unit that determines whether the memory dump processing is being executed, requests a restart or a shutdown of the information processing device when the memory dump processing is not being executed, and requests the restart or the shut down of the information processing device after a second time period passes if the memory dump processing is being executed.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an information processing device according to an embodiment,

FIG. 2 is a block diagram illustrating a hardware configuration example of a computer according to an embodiment,

FIG. 3 is a block diagram illustrating a function of a computer according to an embodiment,

FIG. 4 is a diagram illustrating a screen display example of a case when a memory dump processing is executed,

FIG. 5 is a diagram illustrating a screen display example of a case when a hardware error occurs,

FIG. 6 is a flowchart illustrating a flow of processing of an operation state monitoring unit in case of fault occurrence.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

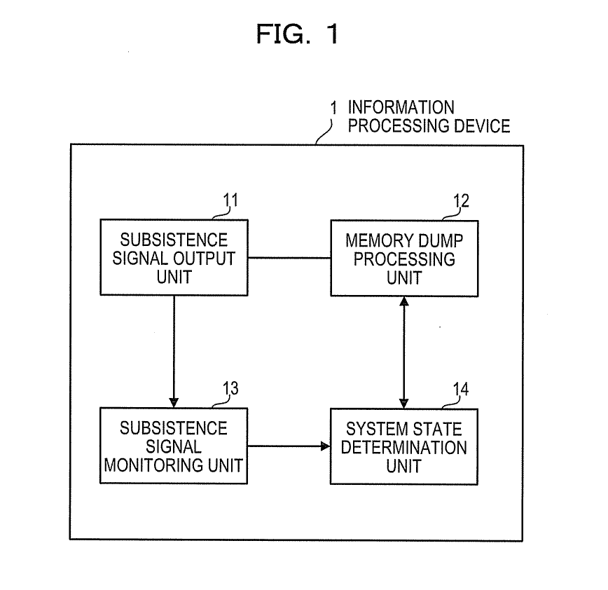

An embodiment will be described in detail below with reference to the diagrams. FIG. 1 is a diagram illustrating an information processing device according to an embodiment. An information processing device 1 illustrated in FIG. 1 includes a subsistence signal output unit 11, a memory dump processing unit 12, a subsistence signal monitoring unit 13, and a system state determination unit 14.

While the information processing device 1 is normally operating, the subsistence signal output unit 11 repeatedly (continuously) outputs a subsistence signal indicating that the information processing device 1 is normally operating. The memory dump processing unit 12 executes a memory dump processing of collecting a memory content and recording the collected information in a nonvolatile storage area inside the information processing device 1. The memory dump processing is executed as necessary when a fault occurs in the information processing device 1. Furthermore, the memory dump processing, as interruption processing, for example, is executed in reference to the processing of the subsistence signal output unit 11. Therefore, during execution of the memory dump processing, the subsistence signal is not output from the subsistence signal output unit 11.

The subsistence signal monitoring unit 13 monitors the subsistence signal output from the subsistence signal output unit 11. After the subsistence signal is once output, the subsistence signal monitoring unit 13 monitors whether or not the subsistence signal is output again within a specified time period (a first time period, for example).

The system state determination unit 14 has a function for monitoring whether or not the information processing device 1 is normally operating and for restarting the information processing device 1 if a fault occurs. According to an embodiment, the information processing device 1 may be shut down instead of being restarted.

Based on monitoring information of the subsistence signal monitoring unit 13, the system state determination unit 14 determines that a fault occurs if the subsistence signal is not output again from the subsistence signal output unit 11 within the first time period. Then the system state determination unit 14 determines whether or not the memory dump processing by the memory dump processing unit 12 is being executed.

If the memory dump processing is being executed, a monitor of the information processing device 1 displays that the memory dump processing is being executed. The system state determination unit 14 may determine whether or not the memory dump processing is being executed based on the above-described display information, for example.

If the system state determination unit 14 determines that the memory dump processing is being executed, the system state determination unit 14 measures a specified time period (a second time period, for example). After the second time period passes (lapses), the information processing device 1 is restarted. That is, the system is not restarted immediately because of non-transmission of the subsistence signal. The timing to restart the system is delayed if the memory dump processing is being executed. The above-described processing may complete the memory dump processing more positively.

On the other hand, if the system state determination unit 14 determines that the memory dump processing is not being executed, the information processing device 1 may be restarted immediately. Moreover, the system state determination unit 14 may determine whether or not the occurred fault requests the memory dump processing. In this case, if the memory dump processing is requested, the system state determination unit 14 requests the memory dump processing unit 12 to execute the memory dump processing, and the information processing device 1 is restarted after the second time period passes. On the other hand, if the memory dump processing is not requested, the information processing device 1 is restarted immediately.

The above-described processing may execute and complete the memory dump processing without fail even if the memory dump processing is not restarted due to some fault. On the other hand, if the occurred fault does not request the memory dump processing, the information processing device 1 may be restarted in a short time without requiring extra time.

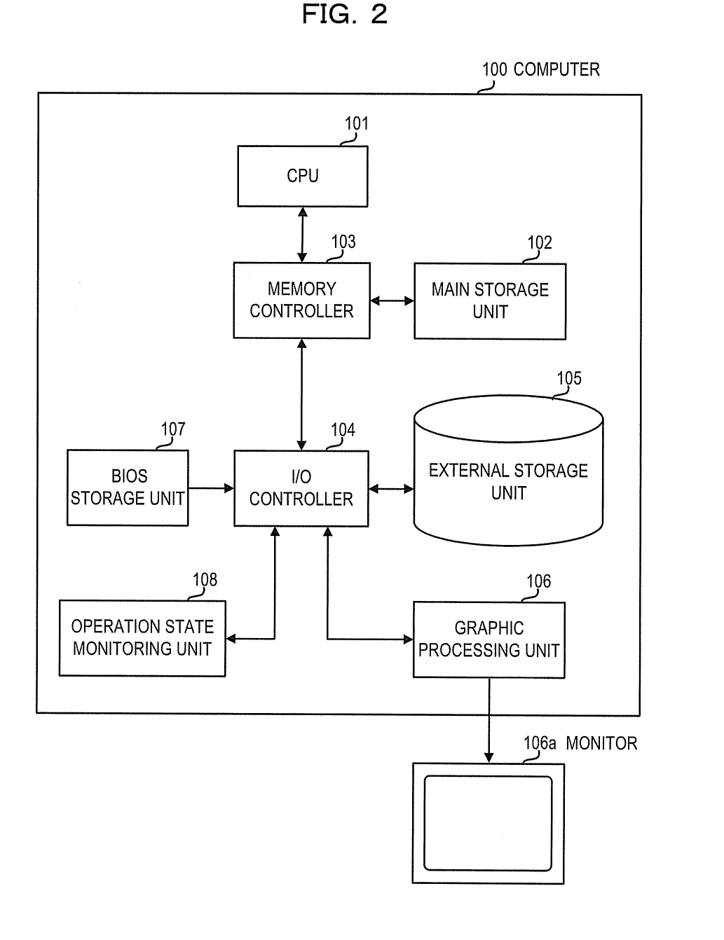

Next, a more specific example will be given to describe the above-described information processing device 1. FIG. 2 is a block diagram illustrating a hardware configuration example of a computer according to an embodiment.

A computer 100 illustrated in FIG. 2 includes a Central Processing Unit (CPU) 101, a main storage unit 102, a memory controller 103, an In/Out (I/O) controller 104, an external storage unit 105, a graphic processing unit 106, a Basic Input/Output System (BIOS) storage unit 107, and an operation state monitoring unit 108.

The CPU 101 controls the whole computer 100. The main storage unit 102 may be implemented as, for example, a Dynamic Random Access Memory (DRAM) or the like and is connected with the CPU 101 through the memory controller 103. The main storage unit 102 temporally stores at least a part of program(s) to be executed by the CPU 101 and various data necessary for the processing by the program. The memory controller 103 controls input/output of data (data exchange) between the CPU 101 and the main storage unit 102.

The I/O controller 104 controls the external storage unit 105, the graphic processing unit 106, the BIOS storage unit 107, and the operation state monitoring unit 108, which are connected with the I/O controller 104, and controls input/output of the data between the CPU 101 and the I/O controller 104. The external storage unit 105 may be implemented as, for example, a Hard Disk Drive (HDD). The external storage unit 105 stores an OS, application programs, and various data. The graphic processing unit 106 is connected with a monitor 106a. The graphic processing unit 106 displays information including an image on the image of the monitor 106a according to an instruction from the CPU 101.

The BIOS storage unit 107 may be implemented, for example, a flash Read Only Memory (ROM). The BIOS storage unit 107 stores a start program for starting the computer 100 to start the OS and BIOS data that includes various data necessary for the start.

The operation state monitoring unit 108 monitors an operation state of the computer 100 (mainly the operation state of the OS) and executes the memory dump processing, restart processing of the computer 100, or the like, if necessary. The operation state monitoring unit 108 has a configuration in which, for example, a CPU, a memory, and the like are disposed on the same substrate. The operation state monitoring unit 108 achieves the above-described function by execution of firmware, recorded in the memory, by the CPU.

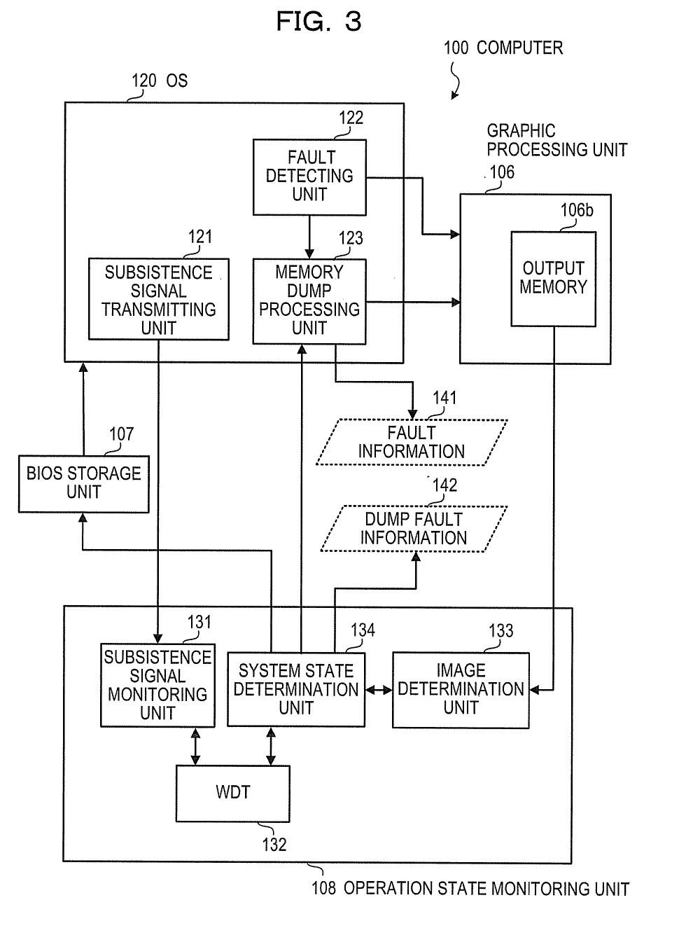

FIG. 3 is a block diagram illustrating a function of a computer according to an embodiment. The computer 100 includes a subsistence signal transmitting unit 121, a fault detecting unit 122, and a memory dump processing unit 123 operating in conjunction with an OS 120. The computer 100 may also include a subsistence signal monitoring unit 131, a watchdog timer (WDT) 132, an image determination unit 133, and a system state determination unit 134 operating in conjunction with the operation state monitoring unit 108. The operation state monitoring unit 108 achieves these functions by, for example, execution of a specified firmware by the CPU provided inside the operation state monitoring unit 108.

The subsistence signal transmitting unit 121 transmits a subsistence signal indicating that the computer 100 is normally operating to the operation state monitoring unit 108 at specified intervals. The fault detecting unit 122 monitors whether or not a fault occurs in the computer 100. If occurrence of a fault is detected, the fault detecting unit 122 requests the memory dump processing unit 123 to execute the memory dump processing, if necessary, according to content of the fault. Furthermore, the fault detecting unit 122 transmits display information to display the content of the occurred fault, if necessary, to the graphic processing unit 106 and requests the graphic processing unit 106 to display the display information.

According to an embodiment, a memory dump processing is executed if a software error is detected. If a hardware error is detected, display information indicating an occurrence of hardware error is transmitted to the graphic processing unit 106 by the processing of the fault detecting unit 122.

The memory dump processing unit 123 executes the memory dump processing according to the request from the fault detecting unit 122 or the operation state monitoring unit 108. In the memory dump processing, content of a specified area inside the main storage unit 102 is collected and stored in the external storage unit 105 as a data file of fault information 141. Furthermore, when the memory dump processing is started, the memory dump processing unit 123 transmits the display information indicating that the memory dump processing is started to the graphic processing unit 106 and requests the graphic processing unit 106 to display the display information. As described below, the display information includes information indicating execution process of the memory dump processing, and the like.

At this time, the memory dump processing is executed by the CPU 101 as high-priority interruption processing. Accordingly, during the execution of the memory dump processing, the subsistence signal transmitting unit 121 may not operate. Moreover, if a hardware error occurs, the subsistence signal transmitting unit 121 may not operate.

The subsistence signal monitoring unit 131, which is connected with the watchdog timer 132, monitors whether or not the subsistence signal monitoring unit 131 receives the subsistence signal from the subsistence signal transmitting unit 121 within a specified time period by using the function of the watchdog timer 132. The watchdog timer 132 executes a count-down operation from a specified count initial value. When receiving the subsistence signal from the subsistence signal transmitting unit 121, the subsistence signal monitoring unit 131 resets the count value of the watchdog timer 132 to the count initial value, and the watchdog timer 132 executes the count-down operation again from the count initial value. If the subsistence signal is not received and the count value of the watchdog timer 132 becomes “0,” the watchdog timer 132 automatically executes the count-down operation again from the count initial value. Furthermore, the watchdog timer 132 may add a specified value to the current count value based on the determination by the system state determination unit 134 and may expand the time to be measured.

The image determination unit 133 receives data of an image displayed by the graphic processing unit 106 according to a request from the system state determination unit 134 and then determines content of the image. If the image determination unit 133 determines execution of the memory dump processing, completion of the memory dump processing, or occurrence of a hardware error based on the received image, and the image determination unit 133 reports the determination to the system state determination unit 134.

In this case, the graphic processing unit 106 includes an output memory 106b that temporally stores display information to be output to the monitor 106a, for example. The image determination unit 133 reads the display information stored in the output memory 106b, discriminates (identifies) character information and image information included in the display information by pattern recognition or the like, for example, and executes the above-described determination processing.

Based on the count value of the watchdog timer 132 and the information reported from the image determination unit 133, the system state determination unit 134 determines the state of the occurrence of a fault in the computer 100 and then executes processing according to the determination result. Specifically, if the subsistence signal is not received by the subsistence signal monitoring unit 131 within the specified time period and the count value of the watchdog timer 132 becomes “0,” the system state determination unit 134 determines that a fault occurs and requests the image determination unit 133 to execute the determination processing of the image content. According to the determination result, the system state determination unit 134 processes to request the memory dump processing unit 123 to execute the memory dump processing and to request the restart processing by having the start program of the BIOS storage unit 107 read in the CPU 101.

If the memory dump processing is requested, the specified value is added to the count value of the watchdog timer 132 and monitors the time until the memory dump processing is completed. If the memory dump processing is not completed within the specified time period, a data file of dump fault information 142 indicating that the memory dump processing is not completed within the specified time period is recorded in the external storage unit 105.

According to an embodiment, the function of the memory dump processing unit 123 is achieved as a function with the OS 120. The function of the memory dump processing unit 123 may be achieved by execution of other programs of other than the OS 120 by the CPU 101. Similarly, the function of the fault detecting unit 122 may be achieved by the execution of other programs of other than the OS 120. While some of the functions are illustrated as being implemented as part of the OS 120 and the operation state monitoring unit 108 in FIG. 3, the present invention is not limited thereto. For example, part or all of the functions of the computer 100 may be implemented by hardware or software components.

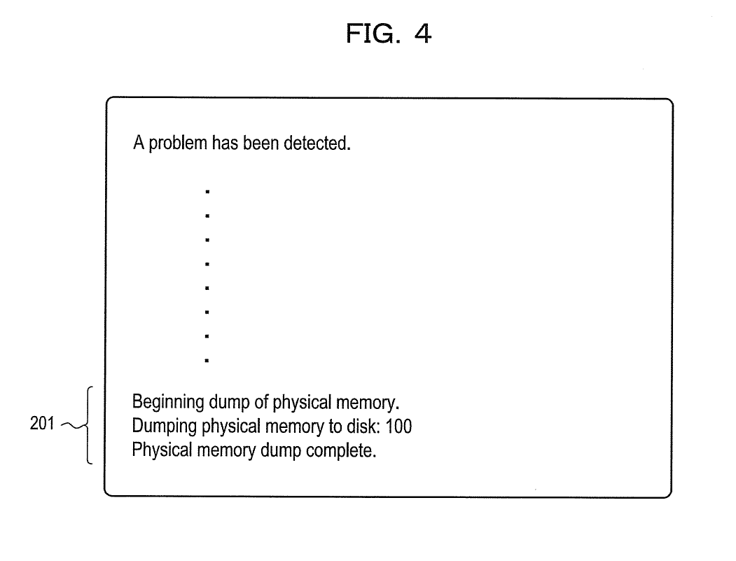

FIG. 4 is a diagram illustrating a screen display example of a case when a memory dump processing is executed. The memory dump processing unit 123 (FIG. 3) displays the image illustrated in FIG. 4 on the monitor 106a at an occurrence of a fault that requests the memory dump processing. In FIG. 4, text information written in a text area 201 is related to the memory dump processing.

When starting the memory dump processing, the memory dump processing unit 123 displays text information in, for example, a first line and a second line of the text area 201. The final numeric value in the second line is information indicating an execution process of the memory dump processing and is indicated as the minimum value “0” immediately after the memory dump processing is started. Then the value gradually increases as the memory dump processing proceeds. When the memory dump processing is completed, the above-described numeric value indicates the maximum value “100” as illustrated in FIG. 4. The text information in the third line of the text area 201 is further displayed and a user is notified that the memory dump processing is completed.

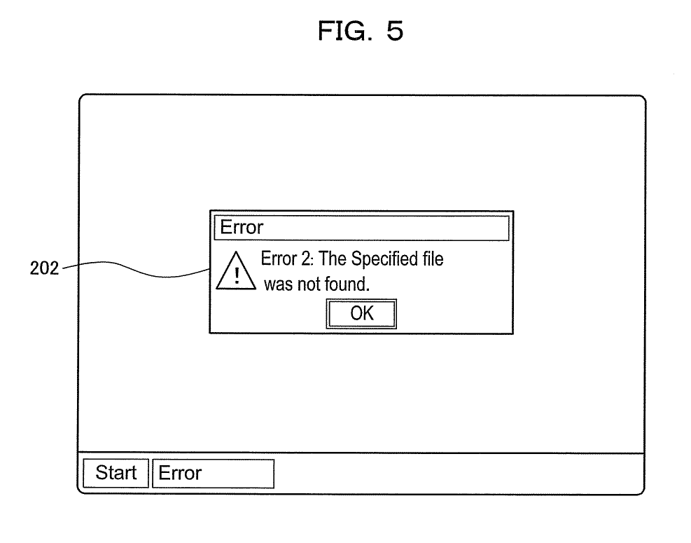

FIG. 5 is a diagram illustrating a screen display example of a case when a hardware error occurs. When occurrence of a hardware error is detected, the fault detecting unit 122 (FIG. 3) displays an error report image 202 as illustrated in FIG. 5 on the monitor 106a. The error report image 202 includes the occurrence of a hardware error, the text information indicating the type and content of the error, and the like. The example of FIG. 5 indicates the type of the hardware error by using a code number, “Error 2.”

The image determination unit 133 holds, in the memory and the like, for example, the text information displayed in the above-described text area 201 and the data of an image pattern corresponding to the error report image 202 in correspondence to identification information. In response to the request from the system state determination unit 134, the image determination unit 133 reads the data of the above-described displayed image from the output memory 106b of the graphic processing unit 106, performs matching of the data with the above-described image pattern, and outputs corresponding identification information to the system state determination unit 134. Based on the identification information from the image determination unit 133, the system state determination unit 134 may determine that the memory dump processing is being executed, the memory dump processing is completed, and a hardware error occurs.

If the image determination unit 133 recognizes the above-described text area 201, the system state determination unit 134 may determine that the memory dump processing is executed based on, for example, image pattern corresponding to the text information in the first line and the second line. After that, the system state determination unit 134 may determine that the memory dump processing is completed based on the text information indicating the final numeric value in the second line and the image pattern of the text information, and the like in the third line.

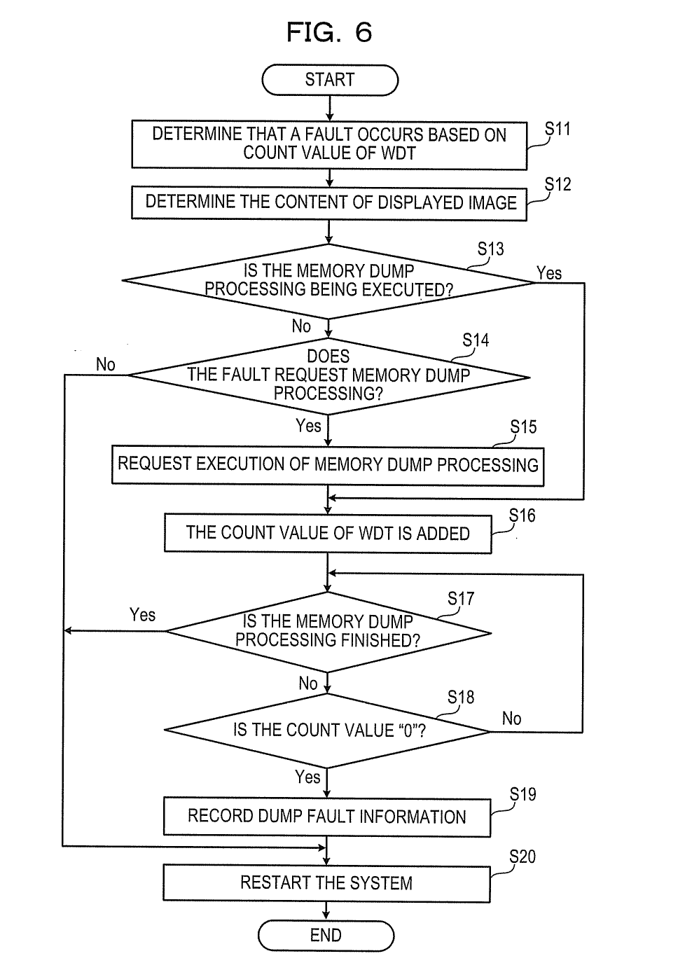

FIG. 6 is a flowchart illustrating a flow of processing of an operation state monitoring unit at occurrence of a fault. As described above, when the computer 100 is being operating, the subsistence signal monitoring unit 131 (FIG. 3) monitors the subsistence signal transmitted from the subsistence signal transmitting unit 121. If the subsistence signal monitoring unit 131 receives the subsistence signal before the count value of the watchdog timer 132 becomes “0,” the subsistence signal monitoring unit 131 determines that the computer 100 is being normally operating and then resets the count value of the watchdog timer 132 to the count initial value.

However, if a fault occurs in the computer 100 and the subsistence signal transmitting unit 121 may not transmit the subsistence signal, the count value of the watchdog timer 132 is counted down to the value “0.” As the fault detecting unit 122 detects a hardware error or a software error, the subsistence signal transmitting unit 121 does not operate when the memory dump processing unit 123 starts the memory dump processing. Thus, no subsistence signal is transmitted. In such a case, the operation state monitoring unit 108 executes the following processing.

At Operation S11, the system state determination unit 134, for example, determines that a fault occurs when the count value of the watchdog timer 132 becomes “0.”

At Operation S12, the system state determination unit 134, for example, requests the image determination unit 133 to perform image determination. The image determination unit 133 reads the data of the displayed image from the output memory 106b of the graphic processing unit 106 and determines the content of the data.

At Operation S13, the system state determination unit 134, for example, receives the above-described identification information as a result of the image determination from the image determination unit 133 and determines the current state of the computer 100. At this time, if the system state determination unit 134 determines that the memory dump processing is being executed, the process at Operation S16 is executed. If not, the process at Operation S14 is executed.

At Operation S14, the system state determination unit 134, for example, determines whether or not the occurred fault requests the memory dump processing based on the determination result from the image determination unit 133. At this time, if a hardware error has occurred, the memory dump processing is not requested by the determination. Then the process at Operation S20 is executed. In other cases, the memory dump processing is requested by the determination. Then the process at Operation S15 is executed.

At Operation S15, the system state determination unit 134, for example, requests the memory dump processing unit 123 to execute the memory dump processing. Therefore, the memory dump processing is started.

At Operation S16, even after the count value became “0” in Operation S11, the watchdog timer 132 continues the count-down operation after resetting the count value to the initial value. After the processing at Operation S15, the system state determination unit 134 adds the specified value to the current count value of the watchdog timer 132 and allows the watchdog timer 132 to continue the count-down operation.

The additional value for this processing is determined in advance in such a way that the time to the count value “0” is the time until the memory dump processing is completed in a normal state. Accordingly, at Operation S16, the count operation is substantially started to determine whether or not the memory dump processing is normally completed. However, this count operation may be executed by another timer function independent of the watchdog timer 132. The count initial value (additional value) of the count operation is optionally changeable by user's inputting operation.

At Operation S17, the system state determination unit 134, for example, requests the image determination unit 133 to continue the image determination and obtains the determination result. If the system state determination unit 134 determines that the memory dump processing is completed, the processing at Operation S20 is executed. If not, the processing at Operation S18 is executed.

At Operation S18, the system state determination unit 134, for example, determines whether or not the count value of the watchdog timer 132 becomes “0.” If the count value is “0,” the processing at Operation S19 is executed. On the other hand, if the count value is greater than “0,” the processing at Operation S17 is executed again.

At Operation S19, the system state determination unit 134, for example, determines that the memory dump processing is not normally completed due to some fault, generates the dump fault information 142 indicating that the memory dump processing is not normally completed, and records the dump fault information 142 in the external storage unit 105.

At Operation S20, the system state determination unit 134, for example, makes the CPU 101 execute the start program stored in the BIOS storage unit 107 to restart the computer 100. At operation S20, the computer 100 may be shut down.

In the above-described processing, when the occurrence of a fault is determined by the count value of the watchdog timer 132 (FIG. 3), the system is not restarted immediately and the state of the computer 100 is determined based on the displayed image. At this time, if the memory dump processing is being executed, the system waits until the memory dump processing is normally completed and is restarted. Therefore, even during the execution of the memory dump processing, the system is not restarted or shut down. Thus, the fault information 141 is surely recorded. This makes it possible to analyze a cause of the fault occurrence based on sufficient information later on. Since the waiting time until the memory dump processing is completed is managed by the watchdog timer 132, the existing functions may be effectively used. Thus, the cost of production and development is reduced.

When the fault occurrence is determined, the system state determination unit 134 determines whether or not the occurred fault requests the memory dump processing if the memory dump processing is not being executed. Since the memory dump processing is executed if necessary, the fault information 141 may be surely recorded even if the memory dump processing is not started for some reason at the occurrence of a fault.

On the other hand, if the occurred fault does not request the memory dump processing, the memory dump processing is not executed and the system is restarted. Accordingly, the time until the system is restarted in this case is shortened.

Furthermore, even when the memory dump processing is executed, the system is restarted if the processing is not completed within the specified time period. Therefore, even when, for example, a fault occurs to the memory dump processing for some reason, the system may be automatically restarted. This eliminates extra time until the system is restarted. Furthermore, in this case, the information indicating that the memory dump processing is not normally completed is recorded as the dump fault information 142. This makes it possible to analyze the cause of the fault of the memory dump processing based on this information.

The state of the computer 100, such as execution or completion of the memory dump processing, is determined based on the displayed image. This eliminates the need to change the program structure and the like of the OS 120 to achieve this determination processing. Therefore, the existing functions may be efficiently used, and the cost of production and development may be reduced.

The function for achieving the determination processing may be provided as a new function using a program or hardware of the OS and the like. At least a part of the above-described determination targets may be determined based on the information (for example, the information that is output by the processing of the OS) other than the displayed image.

According to the above-described embodiment, the memory dump processing is not requested by the determination if a hardware error occurs. However, if the type of the occurred fault may be discriminated more precisely, the determination whether or not the memory dump processing is requested may be performed depending on the type of the fault. In this case, for example, the fault detecting unit 122 outputs the display information whose content varies depending on the type of the occurred fault regardless of hardware error/software error and displays the display information on the monitor 106a. Accordingly, by the processing of the image determination unit 133, the operation state monitoring unit 108 may discriminate the type of the occurred fault more precisely.

According to the above-described embodiment, the additional value of the count value at Operation S16 is determined in advance according to, for example, operation speed of the CPU 101, storage capacity of the main storage unit 102, writing speed of a recording medium in a writing destination of the collected fault information 141, mounted on the computer 100. For example, if the function for monitoring the hardware connected to the computer 100 is provided, the additional value may be calculated every time according to the monitoring information at operation S16. Furthermore, for example, as described above, if the type of the fault may be discriminated more precisely and the time required for the memory dump processing varies depending on the type of the occurred fault, the additional value of the count value may be further calculated and determined according to the type of the fault.

The function (for example, the function of the operation state monitoring unit 108) described in the above-described embodiment may be achieved by a computer. In this case, the program describing the processing content of the above-described function is provided. As the program is executed by the computer, the above-described processing function is achieved on the computer. The program describing the processing content may be recorded in a computer-readable recording medium. A computer-readable recording medium may be a magnetic recording device, an optic disk, an optic magnetic recording medium, a semiconductor memory, and the like.

To distribute a program, for example, a potable recording medium, such as an optic disk in which the program is recorded, is sold. Furthermore, the program may be stored in a storage device of a server computer, and then may be transferred to another computer from the server computer through a network.

The computer that executes the program stores, for example, the program recorded in a portable recording medium or the program transferred from the server computer in the own storage device. Then the computer reads out the program from the storage device and executes processing according to the program. The computer may read out the program directly from the portable recording medium and execute processing according to the program. Furthermore, the computer may execute processing according to the received processing every time when the program is transferred from the server computer.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. An information processing device that has a memory dump processing collecting a memory content of a memory and recording the memory content in a nonvolatile storage area, comprising:
a subsistence signal output unit that repeatedly outputs a subsistence signal indicating a normal operation of the information processing device;
a memory dump processing unit that executes a memory dump processing when necessary by referring to the subsistence signal output unit when a fault occurs in the information processing unit;
a subsistence signal monitoring unit that monitors whether another subsistence signal is output within a first time period after the subsistence signal is output; and
a system state determination unit that determines whether the memory dump processing is being executed, requests a restart or a shutdown of the information processing device when the memory dump processing is not being executed, and requests the restart or the shut down of the information processing device after a second time period passes when the memory dump processing is being executed.

2. The information processing device according to claim 1, wherein the memory dump processing unit outputs display information indicating that the memory dump processing is being executed while the memory dump processing is being executed, and
the system state determination unit determines whether the memory dump processing is being executed based on the display information that is output from the memory dump processing unit.

3. The information processing device according to claim 1, wherein the system state determination unit requests the restart or the shutdown of the information processing device, after the system state determination unit determines that the memory dump processing is being executed and when the system state determination unit does not detect completion of the memory dump processing until the second time period passes, and after recording the information indicating that the memory dump processing is not normally executed in the nonvolatile storage device.

4. The information processing device according to claim 1, wherein the system state determination unit determines whether the occurred fault requests the memory dump processing when the subsistence signal is not output again within the first time period when the memory dump processing is not being executed,
the system state determination unit requests the restart or the shutdown of the information processing unit when the system state determination unit determines that the fault does not request the memory dump processing, and
the system state determination unit requests the memory dump processing unit to execute the memory dump processing when the system state determination unit determines that the fault requests the memory dump processing, and requests the restart or the shutdown of the information processing device after the second time period passes from a point of time.

5. The information processing unit according to claim 4, wherein when detecting occurrence of a fault, a fault detecting unit provided to the information processing device outputs display information for displaying that the occurrence of a fault with a type of the fault, and
the system state determination unit determines whether the occurred fault requests the memory dump processing based on the display information output by the fault detecting unit.

6. The information processing device according to claim 4, wherein after requesting execution of the memory dump processing of the memory dump processing unit, when the system state determination unit does not detect completion of the memory dump processing until the second time period passes, the system state determination unit requests the restart or the shutdown of the information processing device after recording, in the nonvolatile storage device, information indicating that the memory dump processing is not normally executed.

7. The information processing device claim 6, wherein the subsistence signal monitoring unit includes a counter for counting the first time period, and
when the system state determination unit determines that the memory dump processing is being executed, the system state determination unit changes a count value of the counter provided on the subsistence signal monitoring unit and allows the counter to count the second time period.

8. A computer-readable recording medium that records an operation state monitoring program for controlling an information processing device having a memory dump processing function for collecting a memory content of a memory and recording the memory content in a nonvolatile storage area, comprising:
monitoring whether another subsistence signal is output within a first time period after the subsistence signal is output from a subsistence signal output unit of the information processing device, which repeatedly outputs the subsistence signal indicating that the information processing device is normally operating while the information processing device is normally operating;
determining whether a memory dump processing is being executed by the information processing device when the other subsistence signal is not output within the first time period;
requesting a restart or a shutdown of the information processing device when the memory dump processing is not being executed, and requesting the restart or the shutdown of the information processing device after the second time period passes from a point of time when the memory dump processing is being executed.

9. An operation state monitoring method of an information processing device having a memory dump processing function for collecting a memory content of a memory and recording the memory content in a nonvolatile storage area at an occurrence of a fault, comprising:
monitoring whether another subsistence signal is output within a first time period after the subsistence signal is output from a subsistence signal output unit of the information processing device, which repeatedly outputs the subsistence signal indicating that the information processing device is normally operating while the information processing device is normally operating;
determining whether a memory dump processing is being executed by the information processing device when the other subsistence signal is not output within the first time period;
requesting a restart or a shutdown of the information processing device when the memory dump processing is not being executed, and requesting the restart or the shutdown of the information processing device after the second time period passes from a point of time when the memory dump processing is being executed.
